(19) United States
(12) Patent Application Publication
(10) Pub. No.: US 2011/0127985 A1
(43) Pub. Date: Jun. 2, 2011

(54) VOLTAGE CONVERTING APPARATUS

(75) Inventors: Ming-Heng Tsai, Hsinchu City (TW); Yi-Chung Chou, Taipei City (TW)

(73) Assignee: ITE TECH. INC., Hsinchu (TW)

(21) Appl. No.: 12/725,465

(22) Filed: Mar. 17, 2010

(30) Foreign Application Priority Data
Dec. 1, 2009 (TW) 98141040

(51) Int. Cl. G05F 1/10

(52) U.S. Cl. 323/285

(57) ABSTRACT

A voltage converting apparatus is disclosed. The voltage converting apparatus mentioned above includes an error comparator. The error comparator receives a feedback voltage and a reference voltage and generates a control signal according to the feedback voltage and the reference voltage. Moreover, the error comparator includes a differential pair, a first current source, and an offset voltage controlling circuit. The offset voltage controlling circuit receives a ramp enabling signal and adjusts a bias current flowing through at least one of a first and a second output terminal of the differential pair according to the ramp enabling signal.

### CROSS-REFERENCE TO RELATED APPLICATION

This application claims the priority benefit of Taiwan application serial no. 98141040, filed on Dec. 1, 2009. The entirety of the above-mentioned patent application is hereby incorporated by reference herein and made a part of specification.

### BACKGROUND OF THE INVENTION

1. Field of the Invention

The invention relates to a voltage converting apparatus, and particularly to an error comparator of the voltage converting apparatus.

2. Description of Related Art

Since electronic products are being developed to be increasingly multi-functional, power sources having different voltages are often required for operations of circuits which have different functions in the same electronic product. In response to the requirement, a so-called power converter is most applied in an electronic product by designers.

The so-call power converter is a switching voltage regulator. Referring to FIG. 1, FIG. 1 is schematic circuit diagram of a conventional voltage converter 100. The voltage converter 100 includes an error comparator 110, a pulse width modulation (PWM) controller 120, a switching device 130, a filtering circuit 140, and a feedback circuit 150. The error comparator 110 receives a feedback voltage V_{FB} and a reference voltage V_{REF}, and then compares the feedback voltage V_{FB} and the reference voltage V_{REF}. When the feedback voltage V_{FB} is lower than the reference voltage V_{REF}, the PWM controller 120 generates a control signal to the switching device 130, such that the switching device 130 performs a power switching operation. Then, the filtering circuit 140 generates an output voltage V_{OUT}.

The error comparator 110 applied in the conventional voltage converter 100 usually includes a comparator having a differential amplifier which is well known to those skilled in the art. When the error comparator 110 compares the feedback voltage V_{FB} and the reference voltage V_{REF}, a large current is generated because the switching device 130 performs a power switching at the same time. Thus, significant electrical field interference is generated, and the noise induced jitter of the feedback voltage V_{FB} or the reference voltage V_{REF} received by the error comparator 110 occurs due to the noise. The noise induced jitter results in erroneous actions when the feedback voltage V_{FB} is close to the reference voltage V_{REF}, such that stability and accuracy of the output voltage V_{OUT} are reduced. Besides, it also causes a so-called electromagnetic interference (EMI), so that performance of the voltage converting apparatus 100 is affected.

### SUMMARY OF THE INVENTION

The invention provides a voltage converting apparatus which utilizes an error comparator having an offset voltage controlling circuit, such that immunity against noise interference of the voltage converting apparatus is enhanced.

The invention provides a voltage converting apparatus including an error comparator. The error comparator receives a feedback voltage and a reference voltage, and generates a control signal according to the feedback voltage and the reference voltage. The error comparator includes a differential pair, a first current source, and an offset voltage controlling circuit. The differential pair has a first input terminal, a second input terminal, a first common terminal, a second common terminal, a first output terminal, and a second output terminal. The first and second input terminals respectively receive the feedback voltage and the reference voltage. The first and second common terminals are coupled with each other. The first current source is coupled between the first and second common terminals of the differential pair and a first reference voltage. The offset voltage controlling circuit is coupled to the differential pair and receives a ramp enabling signal. The offset voltage controlling circuit adjusts a bias current flowing through at least one of the first and second output terminals of the differential pair according to the ramp enabling signal.

In an embodiment of the invention, the offset voltage controlling circuit includes a ramp current source. The ramp current source is coupled to one of the first and second terminals of the differential pair and receives the ramp enabling signal. The bias current provided by the ramp current source is adjusted into a ramp form with a non-zero slope according to the ramp enabling signal. A constant current source is coupled to another one of the first and second output terminals of the differential pair. Besides, an active load circuit is coupled between the ramp current source, the constant current source and a second reference voltage.

In an embodiment of the invention, the active load circuit includes a first, second and third current mirror. The first current mirror is coupled to the constant current source and the second reference voltage. The second current mirror is coupled to the constant current source and the second reference voltage. The third current mirror is coupled to the first reference voltage, the first current mirror, and the second current mirror.

In an embodiment of the invention, the offset voltage controlling circuit includes a first offset current source, a second offset current source, a first bias resistor, and a second bias resistor. The first offset current source is coupled between one of the first common terminal and the second common terminal of the differential pair and the first reference voltage. The second offset current source is coupled between another one of the first common terminal and the second common terminal of the differential pair and a second reference voltage. The first bias resistor and the second bias resistor are serially connected between the first offset current source and the second offset current source, and the first bias resistor and the second bias resistor are both coupled to the first current source. It should be noted that, the first offset current source and the second offset current source both receive the ramp enabling signal, and adjust each bias current into a ramp form provided by the first and second offset current sources according to the ramp enabling signal.

In an embodiment of the invention, the error comparator further includes an active load circuit. The active load circuit is serially connected between the first and second output terminals and the second reference voltage.

In an embodiment of the invention, the active load circuit is a current mirror.

In an embodiment of the invention, the differential pair includes a first and second transistor. The first transistor has a gate, a first source/drain, a second source/drain, and a base. The gate thereof is coupled to the first input terminal of the differential pair. The first source/drain thereof is coupled to the first common terminal of the differential pair. The second source/drain thereof is coupled to the first output terminal of the differential pair. The second transistor also has a gate, a first source/drain, a second source/drain, and a base. The gate thereof is coupled to the second input terminal of the differential pair. The first source/drain thereof is coupled to the second common terminal of the differential pair. The second source/drain thereof is coupled to the second output terminal of the differential pair.

In an embodiment of the invention, the offset voltage controlling circuit includes a first constant voltage source and an offset voltage source. The first constant voltage source is coupled between the base of the first transistor and a second reference voltage. The offset voltage source is coupled between the base of the second transistor and the second reference voltage. The offset voltage source adjusts a voltage value into a ramp faun provide by the offset voltage source according to the ramp enabling signal.

In an embodiment of the invention, the offset voltage controlling circuit further includes a second constant voltage source serially connected between the base of the second transistor and the offset voltage source.

In an embodiment of the invention, the voltage converting apparatus further includes an active load circuit. The active load circuit is coupled between the first and second output terminals of the differential pair and the second reference voltage.

In an embodiment of the invention, voltage converting apparatus further includes a pulse width modulation (PWM) controller, a switching device, a filtering circuit, and a feedback circuit. The PWM controller is coupled to the error comparator and receives the control signal, and then generates a PWM signal according to the control signal. The switching device is coupled to the PWM controller and receives the PWM signal. Then, the switching device performs a switching operation according to the PWM signal. Moreover, the filtering circuit is coupled to the switching device. The filtering circuit generates an output voltage of the voltage converting apparatus according to the switching operation.

In an embodiment of the invention, the voltage converting apparatus further includes a feedback circuit coupled between the filtering circuit and the error comparator. The feedback circuit divides the output voltage to generate the feedback voltage.

In an embodiment of the invention, the output voltage is fed back as the feedback voltage.

In an embodiment of the invention, the filtering circuit includes an inductor and a capacitor. One end of the inductor is coupled to the filtering circuit, and the output voltage is generated at the other end of the inductor. The capacitor is coupled to the end of the inductor at which the output voltage is generated.

In an embodiment of the invention, the feedback circuit includes a first and second feedback resistor. The first feedback resistor and the second feedback resistor are serially connected with each other and the feedback voltage is generated at a common contact of the first feedback resistor and the second feedback resistor.

Based on the above, the invention utilizes the offset voltage controlling circuit built in the error comparator to adjust a bias current flowing through at least one of the first and second output terminals of the differential pair according to the ramp enabling signal so as to control an offset voltage value between the feedback voltage and reference voltage. Thus, the offset voltage value between the feedback voltage and reference voltage is increased when the internal noise interference of the voltage converting apparatus is significant, such that immunity against noise interference of the voltage converting apparatus is enhanced. Besides, the offset voltage value is gradually decreased after being increased as time increases, such that response time of the error comparator is not increased.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is schematic circuit diagram of a conventional voltage converter 100.

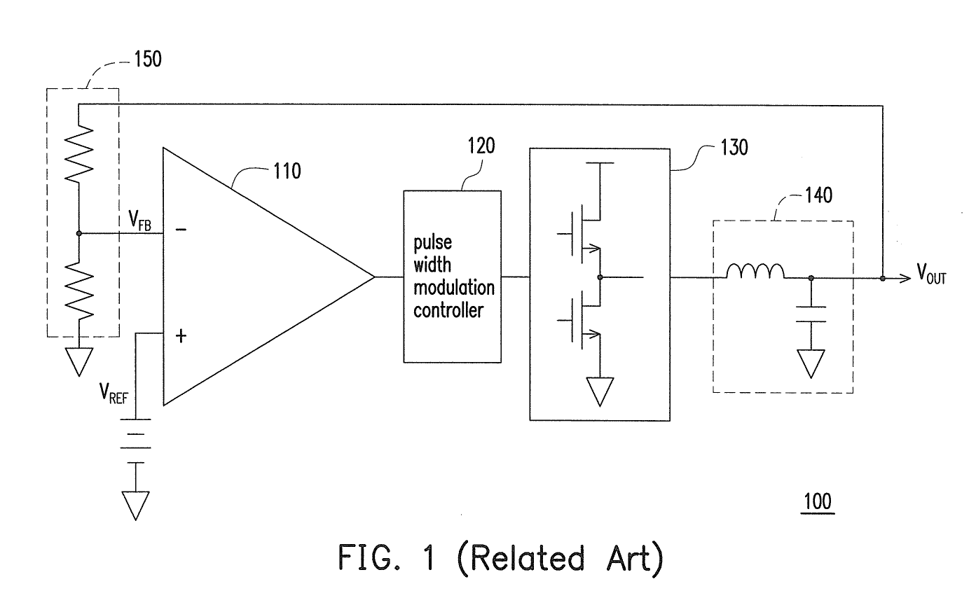

FIG. 2 is a schematic diagram of a voltage converting apparatus 200 according to an embodiment of the invention.

FIG. 3A is a schematic diagram showing an implementation of the error comparator 210 according to an embodiment of the invention.

FIG. 3B is a schematic diagram showing an implementation of an offset voltage controlling circuit 211 according to an embodiment of the invention.

FIGS. 3C˜3D are schematic diagrams showing operation waveforms of the offset voltage controlling circuit 211 of FIG. 3B according to different implementations of the invention.

FIG. 4A is a schematic diagram showing another implementation of the error comparator 210 according to an embodiment of the invention.

FIG. 4B is a schematic diagram showing an implementation of the offset voltage controlling circuit 211 of FIG. 4A.

FIG. 4C is a schematic diagram showing an operation waveform of the offset voltage controlling circuit 211 of FIG. 4B according to an implementation of the invention.

FIG. 5A is a schematic diagram showing another implementation of the error comparator 210 according to an embodiment of the invention.

FIG. 5B is a schematic diagram showing an implementation of the offset voltage controlling circuit 211 of FIG. 5A.

FIG. 5C is a schematic diagram showing an operation waveform of the offset voltage controlling circuit 211 of FIG. 5B according to an implementation of the invention.

### DESCRIPTION OF EMBODIMENTS

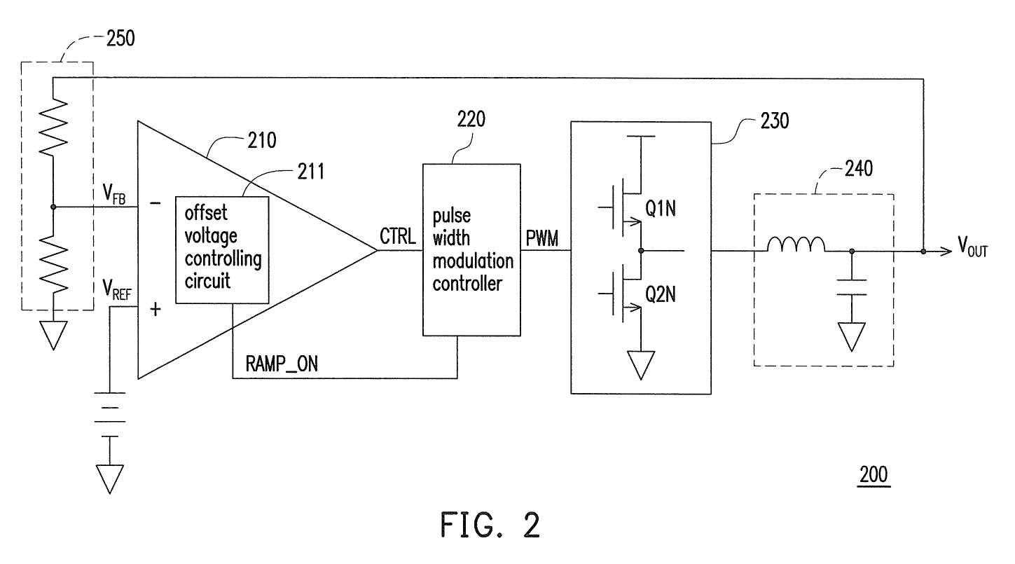

Referring to FIG. 2, FIG. 2 is a schematic diagram of a voltage converting apparatus 200 according to an embodiment of the invention. The voltage converting apparatus 200 of the embodiment includes an error comparator 210, a pulse width modulation (PWM) controller 220, a switching device 230, a filtering circuit 240, and a feedback circuit 250. The error comparator 210 not only receives a feedback voltage V_{FB} and a reference voltage V_{REF}, but also receives a ramp enabling signal RAMP_ON. The error comparator 210 generates a control signal CTRL according to the feedback voltage V_{FB} and the reference voltage V_{REF}. The PWM controller 220 receives the control signal CTRL, and generates a PWM signal PWM according to the control signal CTRL, such that transistors Q1N and Q2N of the switching device 230 perform a switching operation according to the PWM signal PWM. The filtering circuit 240 generates an output voltage V_{OUT} according to the above switching operation. Then, the feedback circuit 250 receives and divides the output voltage V_{OUT} so as to generate the feedback voltage V_{FB}.

It should be noted that, the feedback voltage V_{FB} does not necessarily have to be generated by the feedback circuit 250. The feedback voltage V_{FB} maybe directly set to a constant voltage level. Alternatively, the output voltage V_{OUT} may be directly fed back as the feedback voltage V_{FB}.

The error comparator 210 includes an offset voltage controlling circuit 211, and the ramp enabling signal RAMP_ON is received by the offset voltage controlling circuit 211. The offset voltage controlling circuit 211 receives the ramp enabling signal RAMP_ON and adjusts a bias current of the error comparator 210 so as to achieve adjustment of a bias voltage of the error comparator 210.

Various implementations of the error comparator 210 of the embodiment and detailed operation thereof are illustrated in the following.

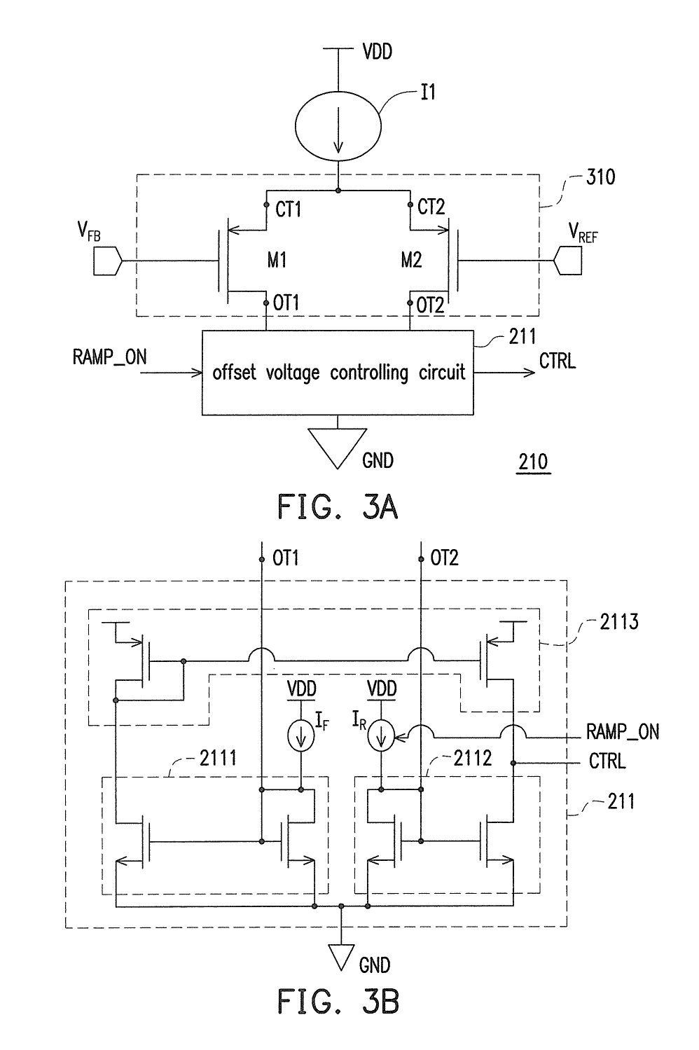

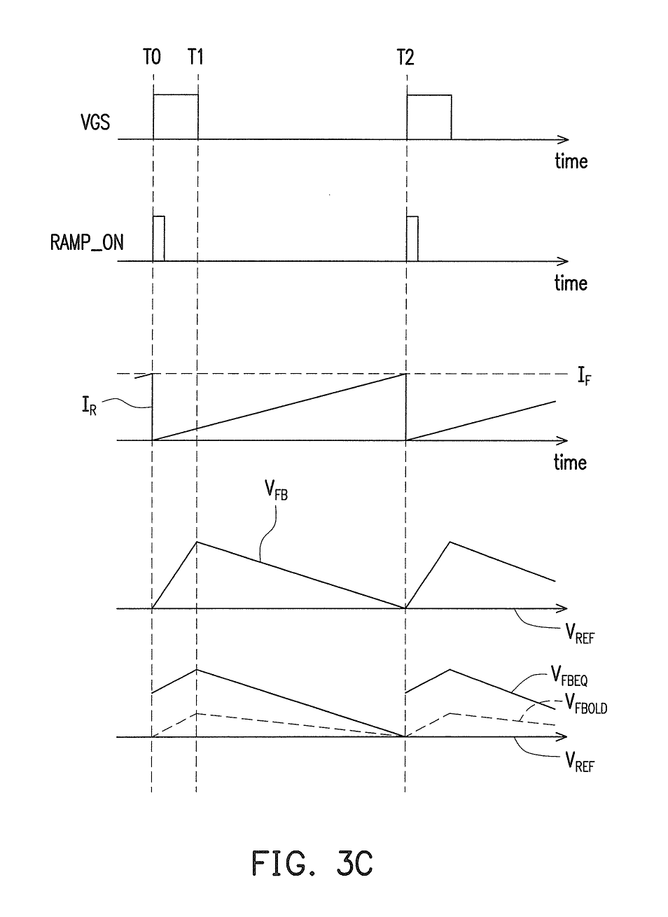

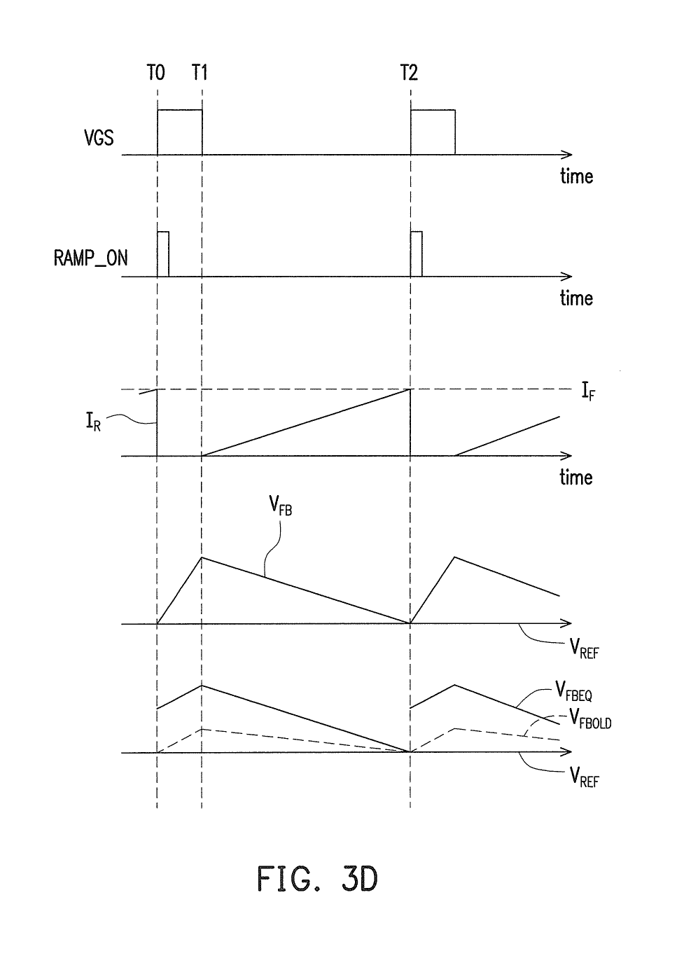

Referring to FIG. 3A, FIG. 3A is a schematic diagram showing an implementation of the error comparator 210 according to an embodiment of the invention. In the implementation, the error comparator 210 includes a differential pair 310, a first current source I1, and an offset voltage controlling circuit 211. The differential pair 310 has a first and second input terminal, a first and second common terminal CT1 and CT2, a first and second output terminal OT1 and OT2. The first and second input terminals are respectively connected with the feedback voltage V_{FB} and the reference voltage V_{REF}. The first common terminal CT1 and the second common terminal CT2 are coupled with each other. The first current source I1 is coupled between the first and second common terminals CT1 and CT2 of the differential pair 310 and a first reference voltage (e.g. a system voltage VDD). The offset voltage controlling circuit 211 is coupled to the first and second output terminals OT1 and OT2 of the differential pair 310.

The differential pair 310 includes transistors M1 and M2. A gate of the transistor M1 is coupled to the first input terminal of the differential pair 310. A first source/drain thereof is coupled to the first common terminal CT1 of the differential pair 310. A second source/drain thereof is coupled to the first output terminal OT1 of the differential pair 310. A gate of the transistor M2 is coupled to the second input terminal of the differential pair 310. The first source/drain thereof is coupled to the second common terminal CT2 of the differential pair 310. The second source/drain thereof is coupled to the second output terminal OT2 of the differential pair 310.

The offset voltage controlling circuit 211 adjusts a bias current flowing through at least one of the first and second output terminals OT1 and OT2 of the differential pair 310 according to the ramp enabling signal RAMP_ON. Description of the detailed operation of the offset voltage controlling circuit 211 adjusting a bias current flowing through at least one of the first and second output terminals OT1 and OT2 of the differential pair 310 is provided below.

Referring to FIG. 3B, FIG. 3B is a schematic diagram showing an implementation of the offset voltage controlling circuit 211 according to an embodiment of the invention. The offset voltage controlling circuit 211 includes a constant current source I_{F}, a ramp current source I_{R}, and an active load circuit. The active load circuit includes mutually coupled current mirrors 2111, 2112 and 2113. The ramp current source I_{R} is coupled to the second output terminal OT2 of the differential pair 310, and the constant current source I_{F} is coupled to the first output terminal OT1 of the differential pair 310. Moreover, the ramp current source I_{R} receives the ramp enabling signal RAMP_ON. When the ramp enabling signal RAMP_ON is enabling (e.g. at logic 1), the ramp current source I_{R} adjusts the bias current provided by the ramp current source I_{R} into a ramp form with a non-zero slope.

Referring to both FIG. 3B and FIG. 3C, FIG. 3C is a schematic diagram showing an operation waveform of the offset voltage controlling circuit 211 of FIG. 3B according to the first implementation. It is assumed that the feedback voltage V_{FB} is received via a negative input terminal of the error comparator 210, and the reference voltage V_{REF} is received via a positive input terminal of the error comparator 210. At the instant when the ramp enabling signal RAMP_ON transitions from logic 0 to logic 1, the current provided by the ramp current source I_{R} is decreased to an offset value lower than the current provided by the constant current source I_{F}. It should be noted that, the time at which the ramp enabling signal RAMP_ON is enabling (i.e. the ramp enabling signal RAMP_ON transitions from logic 0 to logic 1) is when power converting occurs in the switching device 230 of the voltage converting apparatus. At this moment, the operation of the voltage converting results in a current variation with high energy, such that serious noise interference occurs in the voltage converting apparatus. However, when the ramp enabling signal RAMP_ON is in logic 1, the operation of the current provided by the ramp current source I_{R} being decreased to a bias value lower than the current provided by the constant current source I_{F} causes a sudden increase in the difference between the feedback voltage V_{FB} and the reference voltage V_{REF} as shown in FIG. 3C. Thus, the stability of the error comparator 210 is enhanced.

Then, since the internal noise interference decrease as time increases, the current provided by the ramp current source I_{R} is gradually increased, such that the current provided by the ramp current source I_{R} and the current provided by the constant current source I_{F} are the same or substantially the same. As a result, the error comparator 210 returns to a normal operation and continues the next comparing operation.

It should be noted that, if the ramp current source I_{R} of FIG. 3B is coupled to the first output terminal OT1 of the differential pair 310, the constant current source I_{F} is then coupled to the second output terminal OT2 of thereof. Thus, when the ramp enabling signal RAMP_ON is enabling, the current provided by the ramp current source I_{R} requires being decreased to an offset value higher than the current provided by the constant current source I_{F}. In the implementation of FIG. 3C, the difference between the current of ramp current source I_{R} and the current of the constant current source I_{F} is decreased as time increases. In detailed, the value of the current provided by the ramp current source I_{R} linearly approaches the that of the constant current source I_{F} as time increases until the value of the current of the ramp current source I_{R} is the same as that of the constant current source I_{F}.

The variations of the feedback voltage V_{FB} and reference voltage V_{REF} corresponding to the variation of the ramp current source I_{R} are also shown in FIG. 3C. The feedback voltage V_{FB} is gradually increased away from the constant reference voltage V_{REF} between time points T0 and T1 when the gate-drain voltage difference VGS of the transistor Q1N of the switching device 230 is at a high level (i.e. when the transistor Q1N is turned on). Beside, the feedback voltage V_{FB} is gradually decreased close to the constant reference voltage V_{REF} between time points T1 and T2 when the gate-drain voltage difference VGS of the transistor Q1N is at a low level (i.e. when the transistor Q1N is turned off).

However, in consideration of the original offset voltage of the error comparator 210, it is clearly shown in FIG. 3C that the equivalent feedback voltage V_{FBEQ} of the voltage converting apparatus having the offset voltage controlling circuit 211 and the feedback voltage V_{FBOLD} of the voltage converting apparatus without the offset voltage controlling circuit 211 has a difference. As shown in FIG. 3C, compared to the feedback voltage V_{FBOLD}, the equivalent feedback voltage V_{FBEQ} is farther away from the reference voltage V_{REF} at the time point T0.

Referring to both FIG. 3B and FIG. 3D, FIG. 3D is a schematic diagram showing an operation waveform of the offset voltage controlling circuit 211 of FIG. 3B according to the second implementation. The difference between the operation waveform of FIG. 3C and the operation waveform of FIG. 3D lies in that the current of the ramp current source I_{R} is not increased immediately at the time point T0 where the rising edge of the ramp enabling signal RAMP_ON occurs. Instead, the current thereof is remained at an offset value until the time point T1. Then, the current of the ramp current source I_{R} is gradually increased and the value thereof approaches the current of the constant current source I_{F} after the time point T1. However, in consideration of the original offset voltage of the error comparator 210, the voltage difference between the equivalent feedback voltage V_{FBEQ} and the feedback voltage V_{FBOLD} is remained the same from the time point T0 to the time point T1. That is to say, the rising slope of the equivalent feedback voltage V_{FBEQ} is the same as that of the feedback voltage V_{FBOLD}.

As a result, when the transistor Q1N of the switching device 230 is turned on, the offset voltage value between the equivalent feedback voltage V_{FBEQ} and the reference voltage V_{REF} is kept at a great value, such that an erroneous action of the error comparator 210 is avoided.

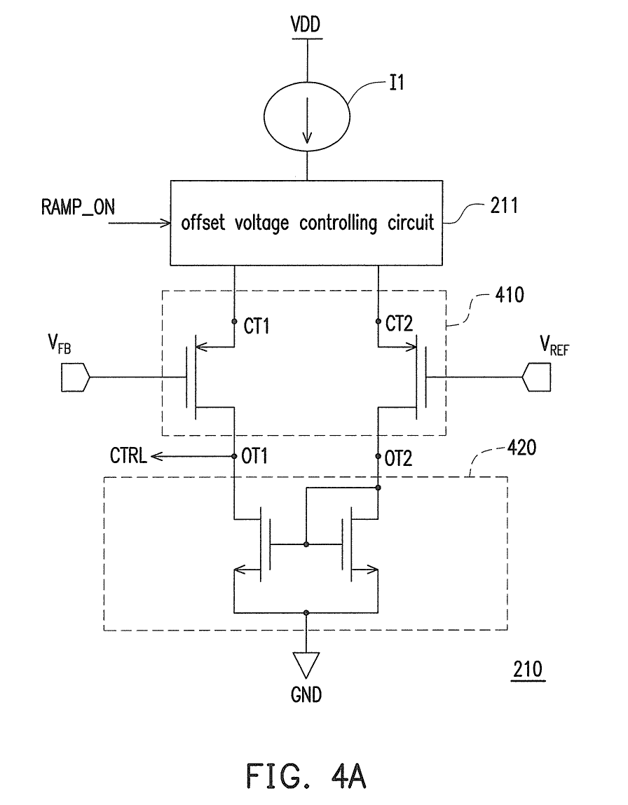

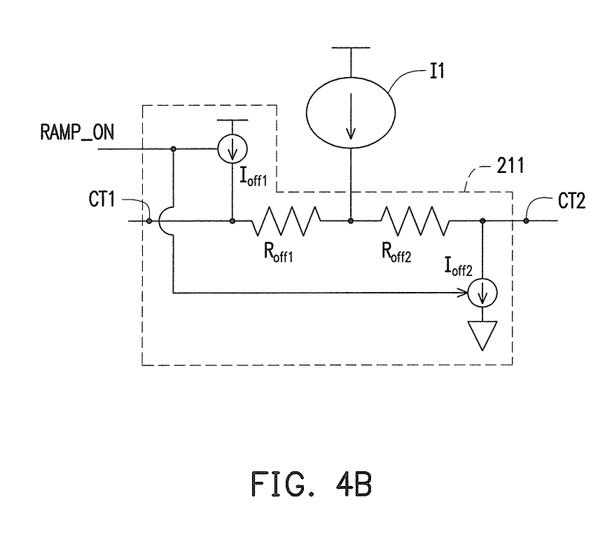

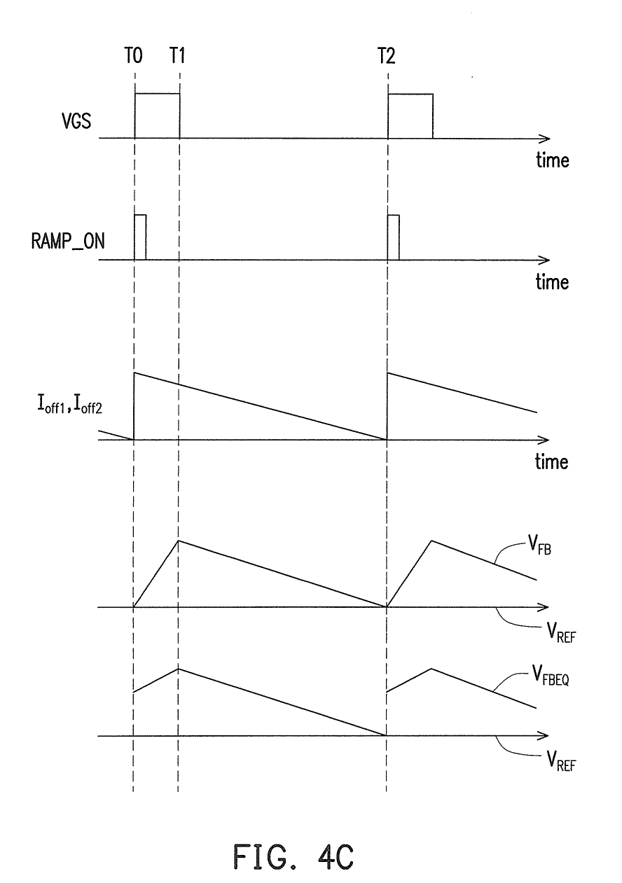

Certainly, the implementation of the error comparator 210 is not limited to FIG. 3A. Referring to FIG. 4A, FIG. 4A is a schematic diagram showing another implementation of the error comparator 210 according to the embodiment of the invention.

The error comparator 210 of FIG. 4A includes a differential pair 410, a first current mirror I1, an offset voltage controlling circuit 211, and an active load circuit 420. In the implementation, the offset voltage controlling circuit 211 is coupled between two common terminals CT1 and CT2 of the differential pair 410. The offset voltage controlling circuit 211 adjusts currents flowing through the common terminals CT1 and CT2 of the differential pair 410 according to the ramp enabling signal RAMP_OUT, such that the currents flowing through the output terminals OT1 and OT2 thereof is adjusted.

The active load circuit 420 is coupled between the two output terminals OT1 and OT2 and a second reference voltage (e.g. a ground voltage GND). In the implementation, the active load circuit 420 includes a current mirror.

Referring to FIG. 4B, FIG. 4B is a schematic diagram showing an implementation of the offset voltage controlling circuit 211 of FIG. 4A. In the implementation, the offset voltage controlling circuit 211 includes offset current sources I_{off1} and I_{off2}, and bias resistors R_{off1} and R_{off2}. The bias resistors R_{off1} and R_{off2} are serially connected between the offset current sources I_{off1} and I_{off2}. The bias resistors R_{off1} and R_{off2} both coupled to the first current source I1.

The offset current sources I_{off1} and I_{off2} simultaneously receive the ramp enabling signal RAMP_ON, and then the currents provide by the offset current sources I_{off1} and I_{off2} are adjusted at the same time according to the ramp enabling signal RAMP_ON. Referring to both FIG. 4B and 4C, FIG. 4C is a schematic diagrams showing an operation waveform of the offset voltage controlling circuit 211 of FIG. 4B. It is also assumed that the feedback voltage V_{FB} is received via the negative input terminal of the error comparator 210, and the reference voltage V_{REF} is received the positive input terminal thereof. At the instant when the ramp enabling signal RAMP_ON transitions from logic 0 to logic 1, the currents provided by the offset current sources I_{off1} and I_{off2} are simultaneously increased by an offset value by the offset current sources I_{off1} and I_{off2}. When the offset current source I_{off1} and the offset current source I_{off2} are the same, the relation of the bias resistors R_{off1} and R_{off2} and the offset current sources I_{off1} and I_{off2} can be expressed as the following equation (1):

V_{FB}−V_{REF}=I_{off1}×(R_{off1}+R_{off2}) (1)

Since the current of the offset current source I_{off1} gradually is decreased as time increases after being increasing at the instant, the difference between the feedback voltage V_{FB} and the reference voltage V_{REF} is decreased as well. The decreasing slope is determined according to the offset current source I_{off1} and the bias resistors R_{off1} and R_{off2}.

However, in consideration of the original offset voltage of the error comparator 210, the equivalent feedback voltage V_{FBEQ} is farther away the reference voltage V_{REF} the from the time point T0 to the time point T1.

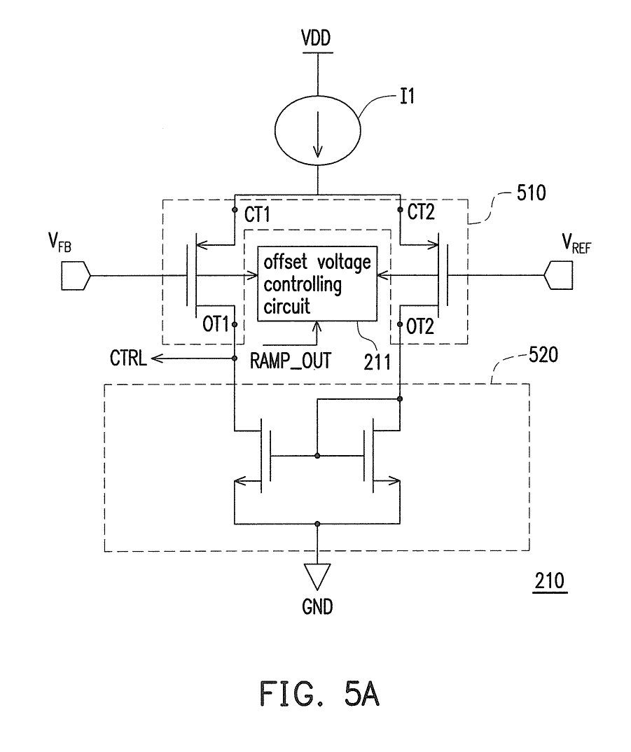

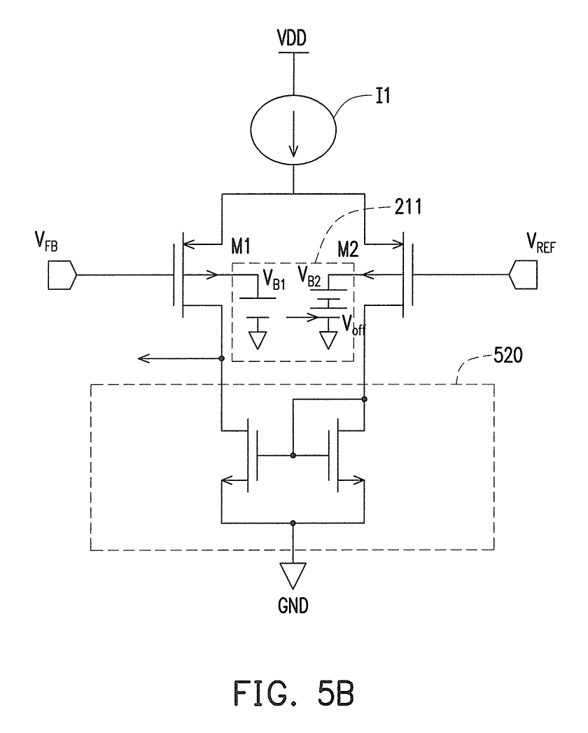

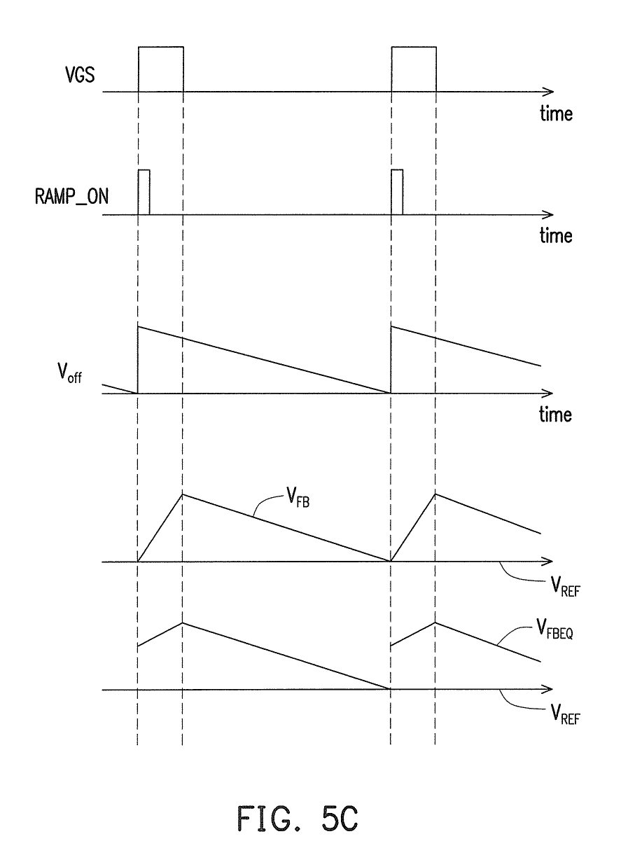

Referring to FIG. 5A, FIG. 5A is a schematic diagram showing another implementation of the error comparator 210 according to an embodiment of the invention.

The error comparator 210 of FIG. 5A includes a differential pair 510, a first current mirror I1, the offset voltage controlling circuit 211, and an active load circuit 520. In the implementation, the offset voltage controlling circuit 211 is coupled to bases of two transistors M1 and M2 of the differential pair 510. The offset voltage controlling circuit 211 adjusts the voltages at the bases of the transistors M1 and M2 and adjusts threshold voltages of the transistors M1 and M2. In addition, the active load circuit 520 is coupled between the differential pair 510 and the ground voltage GND.

Then, referring to FIG. 5B, FIG. 5B is a schematic diagram showing an implementation of the offset voltage controlling circuit 211 of FIG. 5A. In the implementation, the offset voltage controlling circuit 211 includes constant current sources V_{B1} and V_{B2}, and an offset voltage source V_{off}. The constant voltage source V_{B1} is coupled between the base of the transistor M1 and a second reference voltage (e.g. a ground voltage). The constant voltage source V_{B2} and the offset voltage source V_{off} are serially connected between the base of the transistor M2 and the second reference voltage (e.g. a ground voltage).

Referring to both FIG. 5B and 5C, FIG. 5C is a schematic diagram showing an operation waveform of the offset voltage controlling circuit 211 of FIG. 5B. It is also assumed that the feedback voltage V_{FB} is received via the negative input terminal of the error comparator 210, and the reference voltage V_{REF} is received the positive input terminal thereof. At the instant when the ramp enabling signal RAMP_ON transitions from logic 0 to logic 1, voltage provided by the offset voltage source V_{off} is increased by an offset value by the offset voltage source V_{off}. Besides, the voltage is gradually decreased almost to 0 as time increases.

Similarly, in consideration of the original offset voltage of the error comparator 210, the equivalent feedback voltage V_{FBEQ} is farther away the reference voltage V_{REF} from the time point T0 to the time point T1.

In summary, the invention utilizes the offset voltage controlling circuit built in the error comparator of the voltage converting apparatus to receive the ramp enabling signal. Then, the offset voltage controlling circuit adjusts the bias current flowing through at least one of the first and second output terminals of the differential pair according to the ramp enabling signal. Thus, the offset voltage value of the error comparator is increased when the internal noise interference of the voltage converting apparatus is significant.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A voltage converting apparatus, comprising:
an error comparator, receiving a feedback voltage and a reference voltage and generating a control signal according to the feedback voltage and the reference voltage, the error comparator comprising:
a differential pair, having a first input terminal, a second input terminal, a first common terminal, a second common terminal, a first output terminal, and a second output terminal, wherein the first and second input terminals respectively receive the feedback voltage and the reference voltage, and the first and second common terminals are coupled with each other;
a first current source, coupled between the first and second common terminals of the differential pair and a first reference voltage, and
a offset voltage controlling circuit, coupled to the differential pair, receiving a ramp enabling signal and adjusting a bias current flowing through at least one of the first and second output terminals of the differential pair according to the ramp enabling signal.

2. The voltage converting apparatus of claim 1, wherein the offset voltage controlling circuit comprises:
a ramp current source, coupled to one of the first and second output terminals of the differential pair, receiving the ramp enabling signal, and adjusting the bias current provided by the ramp current source into a ramp form with a non-zero slope according to the ramp enabling signal;
a constant current source, coupled to another one of the first and second output terminals of the differential pair; and
an active load circuit, coupled between the ramp current source, the constant current source and a second reference voltage.

3. The voltage converting apparatus of claim 2, wherein the active load circuit comprises:
a first current mirror, coupled to the constant current source and the second reference voltage;
a second current mirror, coupled to the ramp current source and the second reference voltage;
a third current mirror, coupled to the first reference voltage, the first current mirror, and the second current mirror.

4. The voltage converting apparatus of claim 1, wherein the offset voltage controlling circuit comprises:
a first offset current source, coupled between one of the first common terminal and the second common terminal of the differential pair and the first reference voltage;
a second offset current source, coupled between another one of the first common terminal and the second common terminal of the differential pair and a second reference voltage;
a first bias resistor; and
a second bias resistor, wherein the first bias resistor and the second bias resistor are serially connected between the first offset current source and the second offset current source, and the first bias resistor and the second bias resistor are both coupled to the first current source,
wherein the first offset current source and the second offset current source both receive the ramp enabling signal, and adjust each bias current into a ramp form provided by the first and second offset current sources according to the ramp enabling signal.

5. The voltage converting apparatus of claim 4, wherein the error comparator further comprises:
an active load circuit, serially connected between the first and second output terminals and the second reference voltage.

6. The voltage converting apparatus of claim 5, wherein the active load circuit is a current minor.

7. The voltage converting apparatus of claim 1, wherein the differential pair comprises:
a first transistor having a gate, a first source/drain, a second source/drain, and a base, wherein the gate is coupled to the first input terminal of the differential pair, the first source/drain is coupled to the first common terminal of the differential pair, and the second source/drain is coupled to the first output terminal of the differential pair; and
a second transistor having a gate, a first source/drain, a second source/drain, and a base, wherein the gate is coupled to the second input terminal of the differential pair, the first source/drain is coupled to the second common terminal of the differential pair, and the second source/drain is coupled to the second output terminal of the differential pair.

8. The voltage converting apparatus of claim 7, wherein the offset voltage controlling circuit comprises:
a first constant voltage source, coupled between the base of the first transistor and a second reference voltage; and
an offset voltage source, coupled between the base of the second transistor and the second reference voltage, and adjusting a voltage value into a ramp form provide by the offset voltage source according to the ramp enabling signal.

9. The voltage converting apparatus of claim 8, wherein the offset voltage controlling circuit further comprises:
a second constant voltage source, serially connected between the base of the second transistor and the offset voltage source.

10. The voltage converting apparatus of claim 8, further comprising:
an active load circuit, coupled between the first output terminal, the second output terminal of the differential pair and the second reference voltage.

11. The voltage converting apparatus of claim 10, wherein the active load circuit is a current mirror.

12. The voltage converting apparatus of claim 1, further comprising:
a pulse width modulation controller coupled to the error comparator, receiving the control signal, and generating a pulse width modulation signal according to the control signal;
a switching device coupled to the pulse width modulation controller, receiving the pulse width modulation signal, and performing a switching operation according to the pulse width modulation signal; and
a filtering circuit coupled to the switching device and generating an output voltage of the voltage converting apparatus according to the switching operation.

13. The voltage converting apparatus of claim 12, further comprising:
a feedback circuit, coupled between the filtering circuit and the error comparator, and dividing the output voltage to generate the feedback voltage.

14. The voltage converting apparatus of claim 12, wherein the output voltage is fed back as the feedback voltage.

15. The voltage converting apparatus of claim 12, wherein the filtering circuit comprises:
an inductor having a first end and a second end, wherein the first end is coupled to the filtering circuit, and the output voltage is generated at the second end; and
a capacitor coupled to the second end of the inductor at which the output voltage is generated.

16. The voltage converting apparatus of claim 12, wherein the feedback circuit comprises:
a first feedback resistor; and
a second feedback resistor, wherein the first feedback resistor and the second feedback resistor are serially connected with each other, and the feedback voltage is generated at a common contact of the first feedback resistor and the second feedback resistor.
